(19) United States
(12) Patent Application Publication
(10) Pub. No.: US 2004/0192233 A1
(43) Pub. Date: Sep. 30, 2004

(54) Redundant linear power amplifier system

(75) Inventor: James E. Mitzlaff, Arlington Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/125,334

(22) Filed: Apr. 18, 2002

(51) Int. Cl. H01Q 11/12

(52) U.S. Cl. 455/127.1; 455/91

(57) ABSTRACT

A redundant linear power amplifier (LPA) system is provided for minimizing the loss of power output during malfunction conditions. The redundant LPA system includes a transmitter (102) with redundant LPA units (110, 112) for providing spatial combining redundancy and transmitter polarization diversity. Each LPA unit (110, 112) receives an input signal. The output from one of the LPA units (110) is connected to an antenna (120) and the output from the second LPA unit (112) is phase shifted (117) and then connected to a second antenna (122). Alternatively, the outputs from the LPA units (110, 112) are input into a quadrature hybrid (126) and the output (128) from a first port (131) of the quadrature hybrid (126) is connected to the first antenna (120) and the output (130) from a second quadrature hybrid port (133) is phase shifted (117) and connected to the second antenna (122).

### FIELD OF THE INVENTION

The present invention relates generally to a linear power amplifier system and, more particularly, to a redundant linear power amplifier system having transmitter polarization diversity.

### BACKGROUND OF THE INVENTION

Linear power amplifier systems are used in a variety of different applications, including a system for transmitting cellular signals within a cellular network. Such systems typically include a base station, a tower and antennas mounted generally near the top of the tower. As shown in FIG. 1, the base station may include a linear power amplifier combining scheme. Such a scheme includes a device, such as a wideband exciter 12, for receiving signals from the public switched telephone network and generating corresponding radio signals. The signal from the wideband exciter 12 is then split into two equal signals by a signal splitter 14. The split signals 24, 26 are then fed into a pair of high power amplifiers 20, 22, which amplify the radio signals 24, 26 and feed them into a combiner 28. The combiner 28 takes the two split signals 24, 26 and recombines them into a single signal 30 and feeds the single signal 30 either directly or over a coaxial connection to an antenna 32. The antenna 32 generates a radiated signal in a particular pattern for use by subscriber units, such as cellular phones or the like.

Unfortunately, however, because the single antenna 32 of the amplifier combining scheme radiates a signal only in a particular pattern, a disadvantage of the known amplifier combining scheme is the signal outages caused by long, deep fades at stationary or slow moving subscriber terminals. An additional disadvantage of the amplifier combining scheme is that there exists the possibility of a failing linear power amplifier. In actual use, if there is a linear power amplifier failure, most likely one of the two linear power amplifiers may fail while the other continues to function. However, a combination of a linear power amplifier unit failure and mismatch loss caused by the failed component in conventional linear power amplifier combiner systems will cause excessive power reductions in the signal transmitted by the antenna 32.

### BRIEF DESCRIPTION OF THE DRAWINGS

FIG. 1 illustrates a prior art linear power amplifier combining circuit;

FIG. 2 illustrates a wireless communication system embodying the present invention.

FIG. 3 illustrates a redundant linear power amplifier system with polarization diversity in accordance with a first embodiment of the invention;

FIG. 4 illustrates a redundant linear power amplifier system with polarization diversity in accordance with a second embodiment of the invention; and

FIG. 5 illustrates a redundant linear power amplifier system with polarization diversity in accordance with a third embodiment of the invention.

### DETAILED DESCRIPTION

The present invention generally provides for enabling a redundant linear power amplifier (LPA) system to minimize the loss of power output during malfunction conditions, such as when an LPA unit suffers a failure. The system provides a transmit diversity gain of 3-6 dB that conventional LPA redundancy schemes are unable to provide. This is accomplished using spatial combining to replace passive component combining, thereby reducing passive combining losses. Accordingly, a particular advantage of the present redundant LPA system is that only a 3 dB decrease in output is observed when one LPA fails. In contrast, conventional systems using a passive component combiner may experience a power decrease of up to 6 dB. As such, the present system eliminates the need for failure detection circuitry, since the system continues to function at a high level even with a malfunction in one of the LPA units. Of course, an LPA failure alarm is desirable for maintenance purposes.

The present LPA system also advantageously provides a soft-fail redundancy function because failure by any transmit unit only affects the signals being emitted by that particular unit, so the system continues deliver power to the antenna. Furthermore, the present system uses orthogonally polarized antennas such that phase sweeping causes changes in signal polarization, but not in antenna radiation patterns. As a result, communications with any subscriber units located near the edge of a sector are not affected.

An additional advantage of the disclosed LPA system is the elimination of passive combining losses combined with the transmitter diversity gain also enables reducing transmitter output to the point where transmitter units, or at least their power amplifiers, are able to be mounted at the top of the tower. Accordingly, a “high power” integrated PA, LNA, and Antenna unit or maybe even an integrated BTS and antenna unit with enough power output to serve macrocell applications, but with smaller size and weight than current microcell BTS's, may be provided.

In a particular embodiment, the invention encompasses a transmitter with redundant LPA units for providing spatial combining redundancy and transmitter polarization diversity. A wideband exciter produces at least one signal that is split into two signals by the splitter. Each of the signals is then input into two LPA units. The output from one of the LPA units is connected to an antenna and the output from the second LPA unit is phase shifted and then connected to a second antenna.

In another embodiment, the split outputs from the LPA units are input into a coupler, such as a quadrature hybrid. The output from one port of the quadrature hybrid is connected to one antenna and the output from a second quadrature hybrid port is phase shifted and connected to a second antenna. In still another embodiment, the wideband exciter, splitter and LPA units may be replaced by a pair of transmitter units, such as iDEN Quad-BRs available from Motorola, Inc, of Schaumburg, Ill.

The present invention further encompasses a method for providing redundancy in a linear power amplifier system. The method comprises the steps of receiving at least one user signal and splitting the received signal into two signals. The split signals are inputted into a pair of LPA units. Corresponding amplified signals are outputted by the LPA units and fed into two antennas, which then transmit the signals.

The present invention can be more fully understood with reference to FIGS. 2-5. FIG. 2 is a block diagram depicting a wireless communication system 50 in accordance with a particular embodiment of the present invention. Communication system 50 comprises at least one mobile wireless communication or subscriber unit (SU) 52 in wireless communication with a fixed service provider infrastructure 53. Fixed infrastructure 53 comprises those elements normally required to support communications within wireless system 50 and may conform to a CDMA, TDMA, GPRS, GSM or other architecture. By way of example only, the fixed infrastructure 53 comprises, among other components, an “iDEN” communication system, all components of which are commercially available from Motorola, Inc. of Schaumburg, Ill. The fixed infrastructure 53 preferably comprises an iDEN Enhanced Base Transceiver System (EBTS) 56, including an antenna, an iDEN Dispatch Application Processor (DAP) 55, an iDEN Base Site Controller (BSC) 57 and an iDEN Mobile Switching Center (MSC) 58. The mobile wireless communication unit, SU 52, preferably comprises an iDEN wireless phone. Other infrastructure components may be used as needed. For purposes of simplicity, however, only components of the EBTS 56 necessary to describe the present invention are further described.

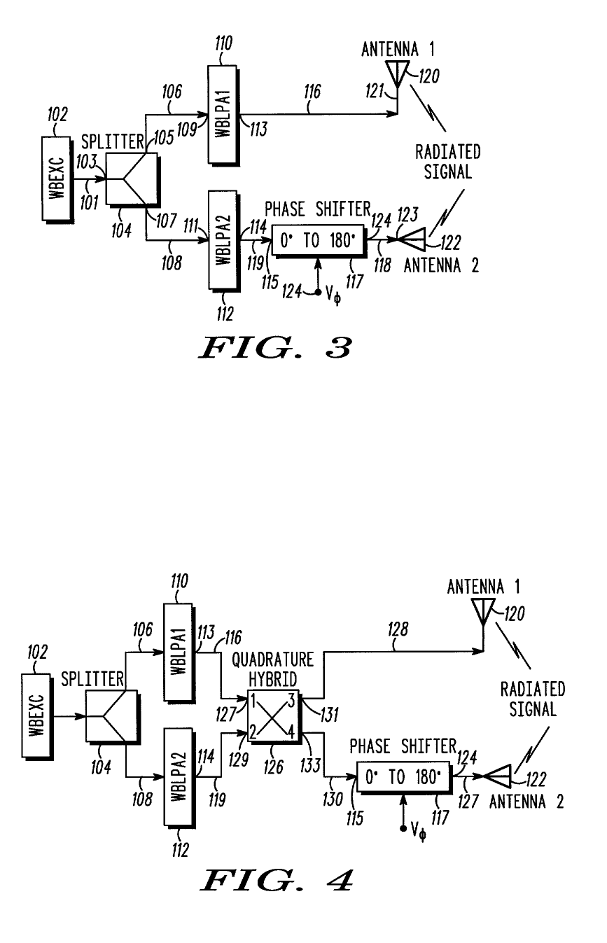

Referring to FIG. 3, there is shown an EBTS 56 in accordance with a first embodiment for providing spatial combining redundancy for a wideband linear power amplifier system and transmitter polarization diversity. The EBTS 56 includes a power amplifier system comprising a wideband exciter (WBEXC) 102, a signal splitter 104, a first wideband linear power amplifier (WBLPA1) 110, a second wideband linear power amplifier (WBLPA2) 112 and a phase shifter 117. The phase shifter 117 may be built as an electromechanical device or by using voltage-variable capacitors (VVC), such as those manufactured by Paratek Microwave of Columbia, Md. A pair of co-located, orthogonally polarized antennas, such as part number UMWD-06515-ODM available from Andrew Corp. of Orland Park, Ill., is provided as well.

The user signals 101 from the WEBXC 102 are fed into an input 103 of the splitter 104. The WEBXC 102 provides a plurality of user signals. The user signals may be combined into a single wideband signal on a carrier frequency such as in “single carrier” code division multiple access (CDMA) or time division multiple access (TDMA) systems. Alternatively, the user signals may be emitted as a plurality of narrow band signals on separate center frequencies such as in a frequency division multiple access (FDMA) system. In another alternative, the user signals may be emitted as a plurality of wideband signals on separate frequencies as used in multi-carrier CDMA and TDMA systems.

The splitter 104 splits the signal 101 into two equal in-phase signals 106, 108 at the two splitter outputs 105, 107, respectively. One of the split signals 106 then is fed into the input 109 of WBLPA1 110 while the other split signal 108 is fed into the input 111 of WBLPA2 112. An output signal 116 from the output 113 of WBLPA1 110 is connected to a first antenna 120. As for the output signal 114 from the output 119 of WBLPA2 120, it is first fed into the input 115 of the phase shifter 117 and then connected to a second antenna 122. The output signals 116, 118 going to the antennas 120, 122 travel over a direct connection between the output 124 of the phase shifter 117 and the second antenna 122 and a direct connection between the output 113 of WBLPA1 and the first antenna 120. Alternatively, the output signals 116, 118 may travel over feeder or coaxial cables 121, 123 connecting the outputs to the antennas, as mentioned above.

The phase shifter 117, which receives the output signal 119 from WBLPA2, is controlled by an input signal V_{Φ} 124, whose magnitude is large enough to produce a total phase variation of at least 180 degrees between its maximum and minimum values. Preferably, the V_{Φ} waveform is one that has a fairly uniform distribution between its minimum and maximum values, such as a triangle wave, sinusoid, or series of steps having substantially uniform amplitude spacing and time duration. If a stepped waveform is used for V_{Φ}, it may be synchronized with the timeslot, frame, or packet structure of the user signal in order to gain optimum benefit from any error correction coding and/or interleaving which may be employed to improve the quality of the signal at an SU.

The phase variation causes the polarization state of the signal 119 to change as a function of time. For example, the connections to the two dipoles in the Andrew Dual Polarized Antenna may have the same polarity. Since these dipoles are oriented at +/−45° from the vertical axis, a phase shifter state of 0° will produce vertical polarization, while a phase shifter state of 90° will produce circular polarization, and a phase shifter state of 180° will produce horizontal polarization. Since only one polarization is likely to be in a deep null at any given SU location, the time varying polarization will prevent the signal at a stationary SU from staying in a deep null for an extended period of time. This provides an effective diversity gain of 3-6 dB when combined with error correction coding and interleaving, as known in the art.

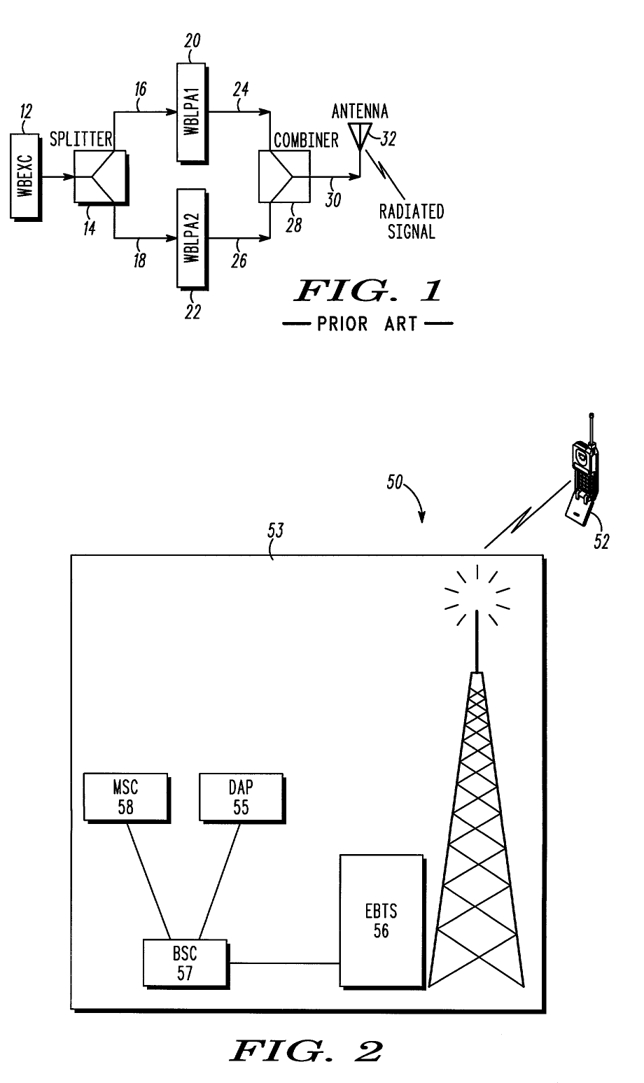

Another feature provided by the system of FIG. 3 is a form of soft-fail redundancy when one of the two WBLPA units fails. During such a failure, the WBLPA unit that is still active continues to deliver power to its antenna. Failure of the single WBLPA unit results in only a 3 dB loss in total radiated signal power. In contrast, prior art LPA combining schemes (FIG. 1) actually suffer a 6 dB loss in radiated signal power upon failure of one of its WBLPA units because half of the output of the good WBLPA unit is dissipated in an isolation load inside the combiner. Thus, a particular advantage of the spatial combining scheme of the present invention is that the need for the isolation load is eliminated along with its associated 3 dB power loss during a fault condition. This is possible because the orthogonally polarized antennas 120, 122 are inherently isolated from each other.

Referring to FIG. 4, the system is shown in an alternate embodiment. In particular, a quadrature hybrid (QH) 126 is inserted between the phase shifter 114 and the linear power amplifiers, WBLPA1 110 and WBLPA2 112. A particular advantage of such a configuration is that transmitter polarization diversity is maintained even during failure of one of the linear power amplifiers. In particular, the QH 126 insures that RF power is always applied to both antennas 120, 122 if either WBLPA1 110 or WBLPA2 112 fails.

In operation, the output signal 116 from the output 113 of the WBLPA1 110 is fed into the first input 127 of the QH 126. The output signal 119 from the output 114 of the WBLPA2 112 is fed into the second input 129 of the QH 126. The output signal 128 from the output 131 of the QH 126 is then fed to the first antenna 120, either through a direct connection or a coaxial connection, as mentioned previously. Similarly, the output signal 130 from the output 133 of the QH 130 is fed into the input 115 of the phase shifter 117. The output signal 127 from the output 124 of the phase shifter 117 is fed into the second antenna 122.

With WBLPA1 110 and WBLPA2 112 active, the two output signals 131, 133 from the QH 126 are in phase with each other, similar to the outputs 116, 119 from WBLPA1 110 and WBLPA2 112 shown in FIG. 2. Therefore, a phase shifter state of 0° continues to produce vertical polarization, while a phase shifter state of 90° produces circular polarization, and a phase shifter state of 180° produces horizontal polarization.

Should either WBLPA1 110 or WBLPA1 112 fail, the two output signals 128, 130 from the QH 126 will have a 90° relative phase shift. In this case, a phase shifter state of 0° produces circular polarization, while a phase shifter state of 90° produces linear (horizontal or vertical) polarization, and a phase shifter state of 180° produces opposite sense circular polarization. Thus, transmission diversity is maintained.

Furthermore, it is of note that failure of either WBLPA1 or WBLPA2 still produces only a 3 dB loss in total radiated signal power. This is because the QH 126 has no isolation load, and its inputs are intrinsically isolated from each other, as are the antennas 120, 122. Thus, a particular advantage of using the QH 126 is that radio frequency (RF) power is always applied to both antennas 120, 122 even when WBLPA1 or WBLPA2 fails.

An additional advantage of the embodiment illustrated in FIG. 4 is that partial redundancy is provided if WBLPA1 110 and WBLPA2 112 do not cover the exact same frequency bands, but provide at least some overlap. For example, if WBLPA1 110 covers the frequency range between 850-870 MHz and WBLPA2 112 covers the frequency range between 860-880 MHz, direct redundancy is provided for signals in the 860-870 MHz band. Indirect, or handover based, redundancy also maybe provided for those signals in the 850-860 MHz and 870-880 MHz bands. In this case, traffic that is being carried by the failed WBLPA unit could be handed over to signals that are within the band of the functional WBLPA unit. Preferably, the WBEXC 102 reduces its signal levels in the 860-870 MHz band by 3 dB, relative to signals in the 850-860 MHz and 870-880 MHz bands. This compensates for the added gain provided by having both WBLPA units active in this band. Under a WBLPA fault condition, however, all signals from the WBEXC 102 should be produced at the same relative levels that are intended for transmission.

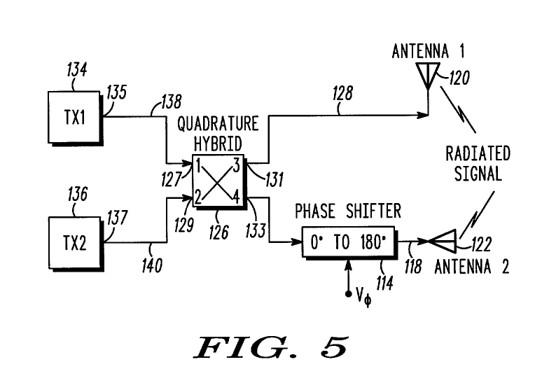

Referring to FIG. 5, the system is shown in still another embodiment, wherein the transmitter units 134, 136 for generating and amplifying an RF carrier signal are used in place of the WBEXC, splitter, WBLPA1 and WBLPA2 shown in FIG. 4. The output 135 of the first transmitter 134 emits a signal 138 that is fed into the input 127 of the QH 126. Similarly, the output 137 of the first transmitter 136 emits a signal 140 that is fed into the input 129 of the QH 126. The output signal 128 from the output 131 of the QH 131 is then fed to ANT1 120, either through a direct connection or a coaxial connection, as mentioned previously. Similarly, the output signal 130 from the output 133 of the QH 130 is fed into the input 115 of the phase shifter 117.

In a first aspect of the embodiment, the transmit units 134, 136 may emit identical signals. In such case, the system behaves in a manner similar to that described in respect to FIG. 4. In another aspect, the transmitter units 134, 136 emits different signals, such as on different frequencies. This enables the system to provide variable polarization transmit diversity to the system, in a manner similar to that described above wherein the QH 126 insures that RF power is always applied to both the antennas 120, 122 if either one of the transmitter units 134, 136 fails. An additional feature of the system is the ability to provide a form of soft-fail redundancy, since failure of either transmitter unit would only affect the signals being emitted by that unit. If there is spare capacity, such as extra available channels, in the functional transmitter unit, then it could be used to replace at least some of the signals that were being emitted by the failed transmitter unit.

While this invention has been particularly shown and described with reference to particular embodiments, it will be understood by those skilled in the art that various changes in form and details may be made therein without departing from the sprit and scope of the invention. The corresponding structures, materials, act and equivalents of all means or step plus function elements in the claims below are intended to include any structure, material or acts for performing the functions in combination with other claimed elements as specifically claimed.

What is claimed is:

1. A redundant linear power amplifier system, comprising:
a wideband exciter for outputting a user signal;
a splitter for receiving the output user signal and splitting the user signal into two split signals;
at least two linear power amplifiers, each linear power amplifier having an input for receiving one of the split signals and an output for outputting corresponding amplified signals; and
at least two antennas, each antenna having an input for receiving the amplified signal from the linear amplifier output and transmitting the received signal.

2. The redundant linear power amplifier system of claim 1, further comprising:
a phase shifter having an input connected to the output of one of the linear power amplifiers and an output connected to the input of one of the antennas, the phase shifter configured to receive the amplified signal from the linear power amplifier and output a phase shifted signal to the antenna input for enabling polarization diversity of the transmitted signal.

3. The redundant linear power amplifier system of claim 2, wherein the phase shifter is controlled by a waveform input signal for enabling the polarization state of the transmitted signal to change as a function of time.

4. The redundant linear power amplifier system of claim 3, wherein the waveform input signal is a stepped signal for enabling synchronization of the waveform with a user signal structure.

5. The redundant linear power amplifier system of claim 1, further comprising a quadrature hybrid having a pair of inputs for receiving and combining the amplified signals from the linear power amplifiers and a pair of outputs for outputting a pair of in-phase signals for input into the two antennas.

6. The redundant linear power amplifier system of claim 5, further comprising:
a phase shifter having an input connected to one output of the quadrature hybrid and an output connected to the input of one of the antennas, the phase shifter configured to receive the amplified signal from the linear power amplifier and output a phase shifted signal to the antenna input for enabling polarization diversity of the transmitted signal.

7. The redundant linear power amplifier system of claim 6, wherein the phase shifter is controlled by a waveform input signal for enabling the polarization state of the transmitted signal to change as a function of time.

8. The redundant linear power amplifier system of claim 7, wherein the waveform input signal is a stepped signal for enabling synchronization of the waveform with a user signal structure.

9. A redundant linear power amplifier system, comprising:
at least two transmitter units for transmitting user signals;
a quadrature hybrid have a pair of inputs for receiving and combining the signals from the two transmitter units and a pair of outputs for outputting a pair of signals;
at least two antennas for receiving and transmitting the signal input into each of the antennas from the quadrature hybrid outputs.

10. The redundant linear power amplifier system of claim 9, further comprising:
a phase shifter having an input connected to one output of the quadrature hybrid and an output connected to the input of one of the antennas, the phase shifter configured to receive the amplified signal from the linear power amplifier and output a phase shifted signal to the antenna input for enabling polarization diversity of the transmitted signal.

11. The redundant linear power amplifier system of claim 10, wherein the phase shifter is controlled by a waveform input signal for enabling the polarization state of the transmitted signal to change as a function of time.

12. The redundant linear power amplifier system of claim 11, wherein the waveform input signal is a stepped signal for enabling synchronization of the waveform with a user signal structure.

13. A method for providing redundancy in a linear power amplifier system, comprising the steps of:
receiving at least one user signal;
splitting the received signal into two signals;
inputting the split signals into a pair of linear power amplifiers and outputting corresponding amplified signals; and
feeding the amplified signal into two antennas and transmitting the received signal.

14. The method of claim 13 further comprising the step of processing at least one amplified signal from at least one of the linear power amplifiers to cause a change in the polarization state of the received signal as a function of time prior to feeding the signal into the antennas.

15. The method of claim 13, wherein the received signal comprises two signals, wherein the two received signals are input into a coupler for outputting equal amplitude level signals that are in phase with one another.

16. The method of claim 15, wherein one of the equal amplitude level signals output by the coupler is input into a phase shifter to enable each of the signals to be of variable phase relative to the other.

17. The method of claim 15, wherein the coupler enables power to be applied to both antennas should one of the linear power amplifiers fail.

18. The method of claim 15, wherein the coupler is a quadrature hybrid.

19. A method for providing redundancy in a linear power amplifier system, comprising the steps of:
receiving a pair of input signals;
inputting the pair of received input signals into a pair of linear power amplifiers and outputting corresponding amplified signals; and
feeding the amplified signal into two antennas and transmitting the received signal.

20. The method of claim 19 further comprising the steps of:
feeding the received pair of input signals into a quadrature hybrid and outputting a pair of corresponding signals;
inputting one of the pair of corresponding signals to a first antenna;
phase shifting the second of the pair of corresponding signals and producing a phase shifted output signal; and
inputting the phase shifted signal to a second antenna.
